(19) United States
(12) Patent Application Publication
(10) Pub. No.: US 2009/0314929 A1
(43) Pub. Date: Dec. 24, 2009

(54) Biomimetic Microfabricated Compound Eyes

(75) Inventors: Luke P. Lee, Orinda, CA (US); Ki-Hun Jeong, Daejeon (KR); Jaeyoun Kim, Ames, IA (US)

Correspondence Address: BUCHANAN, INGERSOLL & ROONEY PC, POST OFFICE BOX 1404, ALEXANDRIA, VA, 22313-1404, US

(73) Assignee: THE REGENTS OF THE UNIVERSITY OF CALIFORNIA, Oakland, CA (US)

(21) Appl. No.: 12/161,321

(22) PCT Filed: Jan. 19, 2007
(86) PCT No.: PCT/US07/01381

§ 371 Date: Mar. 3, 2009

Related U.S. Application Data
(60) Provisional application No. 60/760,704, filed on Jan. 19, 2006.

(51) Int. Cl. G02B 6/06; G02B 27/12; G01D 5/30

(52) U.S. Cl. 250/227.28; 359/619

(57) ABSTRACT

An artificial compound eye comprising a plurality of three-dimensional (3D) self-aligned polymer microlenses disposed on a curvilinear surface; and a plurality of waveguides, wherein each of the waveguides is in optical communication with one of the plurality of polymer microlenses.

### CROSS-REFERENCE TO RELATED APPLICATIONS

This application claims priority to U.S. Patent Provisional Application No. 60/760,704, filed Jan. 19, 2006, which is incorporated herein by this reference in its entirety.

### GOVERNMENT INTEREST

This invention was made with Government support under Grant (Contract) No. N00014-031-1-0808 awarded by the Office of Naval Research. The Government has certain rights to this invention.

### BACKGROUND

Insects possess a completely different optical scheme for its vision unlike other creatures in nature. Compound eyes in nature present intriguing topics in physiological optics because of their unique optical scheme for imaging. For example, a bee's eye has thousands of integrated optical units called ommatidia spherically arranged along a curvilinear surface so that each unit points in a different direction as shown in FIG. 1A. Each ommatidium consists of a light-diffracting facet lens, a crystalline cone, and photoreceptor cells with a wave-guiding rhabdom. The omnidirectionally arranged ommatidium collects incident light with a narrow range of angular acceptance and independently contributes to the capability of wide field-of-view (FOV) detection.

The vision unit called ommatidia is composed of hundreds to ten thousands of facet lenses and rhabdomeres that are arranged along a curvilinear surface. As shown in FIG. 1B, impinging light is collected by a facet lenses, transmitted through rhabdomeres and absorbed to visual pigment molecules. Each rhabdomere is spatially and optically isolated with different refractive indices and aligned to a facet lens. The distinctive features of a single individual ommatidium offer the behavior of a light waveguide and small angular sensitivity. i.e., the small cross-section confines incident light passing through a facet lens to small field of view. The single overall image of compound eyes is integrated by the contiguous field of view of rhabdomeres.

The unique features and functions of natural ommatidia can be artificially imitated by polymeric synthesis based on microoptics. Typically, self-aligned microlens-waveguide systems are capable of small angular acceptance and light guiding were first experimentally demonstrated with an army of elastomer microlenses and self-written waveguides. However, the microfabrication process as well as the characterization method is typically limited to the physical dimensions over one order of magnitude bigger than those of natural ommatidia. In particular, material dissimilarity between polydimethylsiloxane (PDMS) elastomer of microlenses and SU-8 of waveguides obstructs uniform wrapping of the two materials in the case of covering a curvilinear SU-8 surface with flexible PDMS microlens arrays.

It can be appreciated that artificial implementation of compound eyes has attracted a great deal of research interest, because the wide field-of-view (FOV) exhibits a huge potential for medical, industrial, and military applications. Imaging with a field-of-view over 90 degrees has typically been achieved only with fish eye lenses, which rely on bulky and expensive multiple lenses and require stringent alignment. The use of miniaturized, arrayed optical components fabricated by using semiconductor planar processing technologies has been proposed to simultaneously mimic the structure and function of an individual ommatidium and the large-scale collection of ommatidia. The imaging systems using microlens arrays or graded index rod arrays in combination with matching pinhole arrays are good examples. Achieving a wide field-of-view (FOV) in those structures, however, has been hindered mainly by the inherent flatness of the arrayed optical components. In addition, the need to align multiple layers of arrayed components during assembly of the abovementioned imaging systems gives them no advantage over fish eye lenses. For practical implementations of compound eyes with wide field-of-view (FOV), the requirement of curvature-compatible, self-aligned fabrications schemes is evident. In accordance with one embodiment, biologically inspired artificial compound eyes were developed in a small form factor with three-dimensional (3D) configurations.

Accordingly, it would be desirable to have a method of microfabrication of artificial ommatidia, i.e., the microlens-waveguide systems compatible to the physical dimensions of natural ommatidia. In accordance with one embodiment, the polymeric synthesis of artificial ommatidia, both microlens arrays and light waveguides are microfabricated in a photosensitive polymer resin using a soft lithographic process and a UV light self-writing process. In addition, the method can eliminate the material dissimilarity and therefore scale down to the natural ommatidia regime because it can eliminate the handing difficulty in placing elastomer membranes with microlenses on top of polymer resin described in the previous chapter. Herein, a transmission confocal microscopic method is also presented for the characterization of the wave propagation of light coupling onto artificial ommatidia at a couple of microns.

### SUMMARY OF THE INVENTION

In accordance with one embodiment, an artificial compound eye comprises: a plurality of three-dimensional (3D) self-aligned polymer microlenses disposed on a curvilinear surface; and a plurality of waveguides, wherein each of the waveguides is in optical communication with one of the plurality of polymer microlenses.

In accordance with another embodiment, a method of using a compound eye, wherein the compound eye is used in an omnidirectional sensor array.

In accordance with a further embodiment, a method of using a compound eye, wherein the compound eye is used for three-dimensional (3D) holographic optical data storage write/reader.

In accordance with another embodiment, a method of using a compound eye, wherein the compound eye is used in three-dimensional (3D) confocal microcopy.

### BRIEF DESCRIPTION OF THE DRAWINGS

The invention will now be described in greater detail with reference to the preferred embodiments illustrated in the accompanying drawings, in which like elements bear like reference numbers, and wherein:

FIG. 1A shows a perspective view of an optical micrograph of an insect's compound eye, and more particularly in the form of a honeybee's apposition compound eye.

FIG. 1B shows a cross-sectional view of a natural ommatidium, which consists of a facet lens, a crystalline cone, and photoreceptor cells with a wave-guiding rhabdom.

FIG. 2A shows a perspective view of a scanning electron micrograph of an artificial compound eye in accordance with one embodiment.

FIG. 2B shows a cross-sectional view of an artificial ommatidium comprising a microlens, a polymer cone, and an optical waveguide that has a higher index core surrounded by a lower index cladding in a polymer resin, wherein light impinging onto a microlens is coupled with polymer cones and waveguides and then guided to the end of the waveguide.

FIG. 3 shows a cross-sectional view of an angle between receptors comparing a compound eye to a singlet eye.

FIG. 4 shows perspective view of a honeycomb-packed polymer microlens array on a curvilinear surface in accordance with one embodiment.

FIG. 5A shows a cross-sectional view of the polymer synthesis of artificial ommatidia, comprising a two-step cross-linking mechanisms in accordance with one embodiment.

FIG. 5B shows a cross-sectional view of the polymer synthesis of artificial ommatidia in the form of a self-aligned microlens-waveguide.

FIG. 5C shows a cross-sectional view of the polymer synthesis of an artificial ommatidia and a photosensitive polymer resin.

FIG. 5D shows a cross-sectional view of the polymer synthesis of an artificial ommatidia and a photosensitive polymer resin prior to lens-assisted radial UV exposure and thermal cross-linking for self-written waveguides.

FIG. 5E shows a cross-sectional view of the polymer synthesis of an artificial ommatidia and the photosensitive polymer resin upon exposure to the lens-assisted radial UV exposure and thermal cross-linking for self-written waveguides.

FIG. 5F shows a cross-sectional view of the polymer synthesis of an artificial ommatidia and the photosensitive polymer resin upon heat treatment at the degradation temperature of photoacid generator (PAG).

FIG. 6 shows a simulated refractive index distribution of polymer waveguides formed by microlens-assisted self-writing by four different values of E, wherein Eth is the threshold irradiation dose that can initiate the crosslinking process in the polymer.

FIG. 7 shows the formation of polymer cones and waveguide cores self-written by 300-μm-diameter microlenses depending on UV exposure.

FIG. 8 shows a dark-field micrograph of polymer cones and waveguide cores placed on a substrate after completely dissolving unexposed portions in a solvent before thermal cross-linking

FIG. 9 shows an optically sectioned confocal micrographs of light at 635 nm coupled through an artificial ommatidium before UV exposure (only microlens), after UV exposure (waveguide core by photocross-linking), and after UV exposure and thermal cross-linking.

FIGS. 10A-G show a cross-sectional view of a three-dimensional (3D) polymer synthesis of biomimetic artificial compound eyes in accordance with one embodiment.

FIG. 11A shows a cross-sectional view of a lens-assisted radial UV exposure and thermal cross-linking for self-written waveguides in accordance with one embodiment.

FIG. 11B shows a cross-sectional view of a lens-assisted radial UV exposure and thermal cross-linking for self-written waveguides in accordance with another embodiment.

FIG. 12 shows a perspective view of a spherical arrangement of 8370 artificial ommatidia on a hemispherical polymer dome 2.5 mm in diameter.

FIG. 13 shows a perspective view of a hexagonal microlens in accordance with one embodiment.

FIG. 14 shows a perspective view of a cross section with the spherical arrangement of artificial ommatidia consisting of microlenses, polymer cones, and waveguide arrays

FIG. 15 shows a schematic diagram of an experimental setup of a modified transmissive confocal microscope in accordance with one embodiment.

FIG. 16 shows an optically sectioned three-dimensional (3D) confocal image of an artificial compound eye coupled with normal incident light at 532 nm and the intensity distribution obtained along line a-a and b-b.

FIG. 17A shows a system and method for collecting point spread functions of a single ommatidium.

FIG. 17B shows a chart comparing the angular sensitivity function (ASF) between natural and artificial compound eyes.

FIG. 18 shows a cross-sectional view of a honeycomb-packed hexagonal microlens array in accordance with one embodiment.

FIG. 19A shows a cross-sectional view of the development of an afocal artificial ommatidia by radial UV exposure with polymer wrapping, wherein during UV exposure, self-written waveguide is placed onto the point shifted to the focal plane of microlens exposed to air.

FIG. 19B shows a cross-sectional view of a focal ommatidia and an afocal ommatidia.

FIG. 20 shows a cross-sectional view of a binocular artificial compound eye lens used for sensing distance.

FIG. 21 shows a schematic diagram of an endoscopic optical capsule using an artificial compound eye lenses, a complementary metal-oxide-semiconductor (CMOS) image sensor array, and a wireless communication circuit.

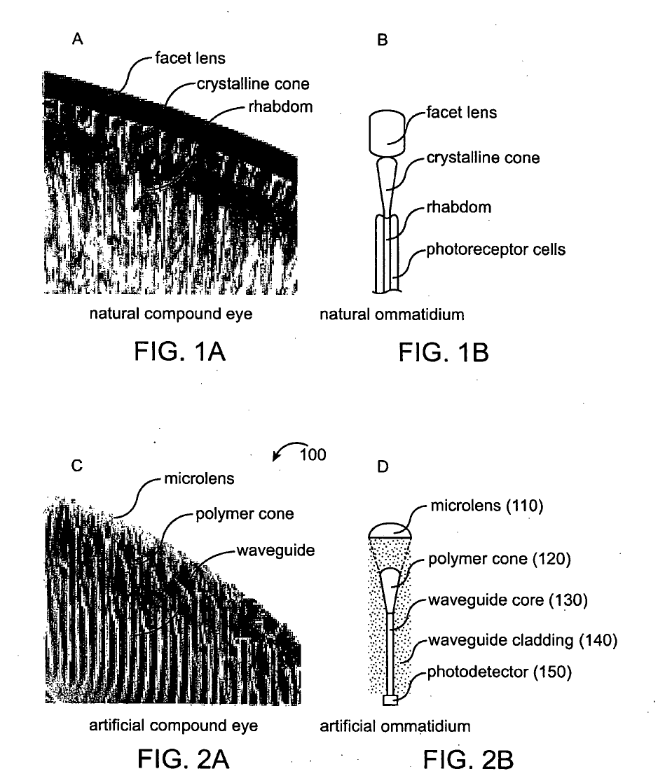

### DETAILED DESCRIPTION

The compound eye in nature consists of a number of ommatidia optically isolated and radially arranged along the circumference of the eye. As an integrated optical unit, each contains a light-diffracting facet lens, a pseudocone, and a wave-guiding rhabdom enveloped by pigment cells. By collecting incident light within a narrow range of angular acceptance, each optical unit independently contributes either to offer the capability of wide field-of-view (FOV) detection or to form an overall mosaic image. Unlike single aperture vision systems, it can be appreciated that multi-aperture optical systems such as compound eyes can offer a new paradigm in miniaturizing imaging system.

In accordance with one embodiment, the distinctive features of natural compound eyes can be mimicked by polymeric synthesis based on microlens, reconfigurable microtemplating, soft lithography, and light induced waveguide technologies. Very similar to natural compound eyes, an artificial compound eye 10 consists of a plurality of artificial ommatidia 100.

FIG. 2A shows a perspective view of a scanning electron micrograph (SEM) of an artificial compound eye 10 comprised of a plurality of artificial ommatidia 100 in accordance with one embodiment. As shown in FIG. 2A, the artificial ommatidium 100, like that of an insect's compound eyes, consists of a refractive microlens 110, a light-guiding polymer cone 120, and a self-aligned waveguide 130 to collect light with a small angular acceptance. Typically, the ommatidia 100 are omnidirectionally arranged along a hemispherical polymer dome such that they provide a wide field of view similar to that of a natural compound eye. The spherical configuration of the microlenses 110 can be accomplished by reconfigurable microtemplating, that is, polymer replication using the deformed elastomer membrane with microlens patterns. The formation of polymer waveguides self-aligned with microlenses can also be realized by a self-writing process in a photosensitive polymer resin. In addition, the angular acceptance can be directly measured by three-dimensional (3D) optical sectioning with a confocal microscope, such that the detailed optical characteristics can be compared with a natural compound eye.

FIG. 2B shows a cross-sectional view of an artificial ommatidium 100 comprising a microlens 110, a polymer cone 120, and an optical waveguide 160 that has a higher index core 130 surrounded by a lower index cladding 140 in a polymer resin 150, wherein light impinging onto a microlens 110 is coupled with polymer cones 120 and waveguides 160 and then guided to the end of the waveguide 160. It can be appreciated that biomimetic compound eyes 10 are anatomically as well as functionally close to natural compound eyes.

As shown in FIG. 2B, the artificial ommatidium 100 consists of a honeycomb-packed hexagonal microlens 110 with a low Fresnel number (N_{F}<10), a cuvette-shaped polymer cone 120, and a polymer or optical waveguide 160 that has a higher index solid core 130 surrounded by a lower index solid cladding 140 in the polymer resin 150. It can be appreciated that three-dimensional (3D) polymer synthesis of an artificial compound eye 10 can be realized through microlens templating, reconfigurable microtemplating, and self-writing in a photosensitive polymer resin. Each ommatidium 100 is omnidirectionally arranged in a hemispherical polymer dome. Like the crystalline cone in nature, the polymer cone 120 helps guide the focused light into the polymer waveguide 160, and subsequently the guided light arrives at the end of the waveguide core 130. Lastly, it can be appreciated that light detection can be done by photodetector arrays. In a three-dimensional (3D) implementation, microlens-assisted self-writing and polymer replication processes can be used to minimize the lens-waveguide coupling loss and to realize a spherical configuration, respectively.

It can be appreciated that in accordance with another embodiment, the polymer microlenses 110 can be substituted for the facet lenses with low Fresnel number. As the parts for light-guiding, a cuvette-shaped polymer cone 120 and a polymer waveguide 160 replace the crystal cone, rhabdomeres, and pigment cell in natural ommatidia. In particular, the formation of a polymer waveguide 160 can be done by a self-writing process. When UV light is focused by microlenses in a photosensitive polymer resin, it can be self-trapped after the focal plane due to the refractive index change resulting from the change in density or chemical bonding that results in photopolymerization with higher refractive index relative to the surrounding. Each waveguide is eventually formed at the focal plane and the optical axis of the microlens 110. The change in the refractive index between the exposed and unexposed portions can be permanently sustained by a thermal heating process. Two crosslinking mechanisms, i.e. photo-crosslinking and thermal-crosslinking, provide the different increment in refractive index for the identical photosensitive polymer resins.

UV light, focusing though microlens and propagating in a photosensitive polymer resin, experiences a unique nonlinear optical phenomenon called self-focusing and self-trapping. Refractive index in the exposed region increases with UV exposure due to the photopolymerization reaction, while the unexposed region remains constant and light is guided along the higher index portion. It can be appreciated that most methods utilize external objective lenses or optical fibers to induce photo-polymerization and monomer in a liquid phase or air as a cladding layer.

In order to make difference between refractive indices of the solid waveguide core and cladding in a photosensitive polymer resin, two different crosslinking mechanisms can be involved. The core portion is initially UV photopolymerized and then followed by a post exposure bake, where the cladding portion is crosslinked by thermal process without photo-polymerization. In accordance with one embodiment, a commercialized negative tone photoresist (Nano™ SU-8) was used as a photosensitive polymer resin. Initially the refractive index of a SU-8 monomer in a liquid phase is 1.550, measured by an Abbe refractometer (LEICA ARIAS 500). A 1.5 μm thick thin monomer film was prepared by spincoating and soft baked at 120° C. for one minute. The index becomes significantly increased to 1.584 due to the evaporation of SU-8 solvent, i.e. Gamma Butyrolactone (GBL) during the soft bake. Refractive index of the solidified SU-8 film is measured by a spectroscopic ellipsometer (SOPRA GESP). With a broad band mercury lamp of conventional photolithographic equipment with light intensity of 13 mW/cm² at 365 nm, the changes in refractive index were measured with UV exposure. It can be appreciated that the index change is linearly proportional to UV exposure by Δnₛᵤ₋₈=10⁻⁵mj⁻¹. The measurements were carried out without a post exposure thermal process to observe the increment due to UV polymerization. The small increment in refractive index due to photopolymerization is substantially increased by a post exposure thermal process that provides the full crosslinking in the resin. The process is done by heating the sample on a hot plate at 120° C. for 1 minute and at 150° C. for 5 minutes. The index of the fully crosslinked SU-8 is 1.614. The other portion used as waveguide cladding also follows the post exposure thermal process without UV exposure. After the thermal process, the refractive index turns into 1.585 and the maximum index change between both crosslinked core and cladding eventually turns out to be Δnₛᵤ₋₈=0.029. This thermal process of the unexposed portion is very crucial to permanently set the index difference between both regions so that it prevents the index change in unexposed area by additional UV exposure. The temperature for the thermal process is determined by the maximum temperature where the functionality of the photoacid generator is not degraded. It can be appreciated that in accordance with one embodiment, a triaryliumsulfonium salt-based photoinitiator used in SU-8 starts to degrade at 130° C. The portions of high index (n=1.614) and low index (n=1.593) function as waveguide core and cladding, respectively.

The index change can be explained by photochromic effects among the dominant mechanisms. For example, when SU-8 is interrogated with ultraviolet light, each of the eight epoxy groups found on the molecule gets protonated and a C—C bond is formed between the epoxy groups on different molecules. For a single bond between different SU-8 molecules to form, two C—O bonds are broken and replaced by two O—H bonds and a single C—C bond. Based on the molar refractions for each of these covalent bonds, there is a net increase in the molar refraction of the molecule which increases the index of refraction. The ultraviolet light is responsible for creating a Lewis acid that protonates the oxygen on each epoxy group. Without the protonation, the net effect on the molar refraction and refractive index would be negative. It can be explained that this is the reason why the index of refraction drops for unexposed SU-8 when it is hard baked without UV exposure. Other reasons for the changes in refractive index could result from density changes of the polymer during polymerization or changes in material composition due to solvent evaporation. In a similar fashion, the index difference can be obtained by choosing a variety of photosensitive polymer resins and the index difference is comparable to that between rhabdomere and surround medium of natural compound eye (typically Δn=0.01˜0.035).

It can be appreciated that in accordance with one embodiment, the distributions of electrical field and the refractive index in a SU-8 resin depending on the F-number of the microlens of 25 μm diameter for the same exposure energy can be shown. Even if self-focusing and diffraction exists at the focus of a low F-number microlens, the electric field is well confined as F-number increases and the refractive index gradually decrease outside the diffraction limit on optical axis. However, the F-number is limited due to the fabrication of microlenses. It can be appreciated that tests have shown that excessive UV exposure may cause the failure of self-focusing even for high F-number microlenses.

In accordance with another embodiment, the microfabrication of the microlens array can be performed with a commercially available negative tone photoresist SU-8, using a replica molding method of soft lithography. The higher refractive index of SU-8 allows the smaller lens thickness and therefore it is beneficial for minimizing optical aberration. First, a convex microlens template is fabricated by reflowing hexagonal or circular islands of a positive photoresist (OCG 825) at 180° C. on a hot plate for 15 minutes (Step 1 and 2). Lens curvature for an identical pupil diameter is determined by the ratio of pupil diameter to initial thickness of the spincoated photoresist prior to resist melting. An anti-stiction layer may need to be deposited on the microtemplate by PECVD (Step 3). The microlens template is replicated with Polydimethylsiloxane (PDMS, Sylgard® 184) elastomer. PDMS monomer is spincoated at 100 rpm on the microlens master and air bubbles trapped between the microlenses are removed in vacuum for 1 hour. PDMS with uniform thickness is baked at 60° C. for 3 hours and peeled off from the master. The elastomer replica is flipped over and mounted on a rigid substrate (Step 4 and 5). SU-8 monomer in a liquid phase can be dispensed onto the elastomer replica to make a couple of hundred microns in thickness. Before SU-8 dispensing, an oxygen plasma treatment of PDMS helps to avoid the droplet formation of the monomer due to low surface energy of PDMS (˜16.0 mJ/m²). The temperature of the soft bake should be determined below the maximum temperature at which the resin starts to get thermally crosslinked. A Su-8 2100 is dispensed onto the elastomer replica with constant volume. The prebake is carried out in an oven at 120° C. for one hour to remove the solvent of SU-8, i.e. Gamma Butyrolactone (Step 6).

The glass transition temperature of SU-8 increases with soft bake temperature. The SU-8 monomer droplet is still compliant at 120° C. above the glass transition temperature (T_{g}=55° C.) at room temperature and therefore the droplet can be thermally formed by pressing with a glass substrate (Step 7). This process is irreversible because the inertia of the droplet is large enough to prevent the shape recovery of SU-8 droplet due to the surface tension between the SU-8 monomer and PDMS. The adhesion between PDMS and SU-8 is weaker relative to that between glass and SU-8 and therefore the PDMS replica is easily peeled off from SU-8 lens patterns on a glass substrate (Step 8). Finally UV exposure is done with a mercury lamp of a conventional mask aligner with broadband wavelengths (Quintel, 13 mW/cm² at 365 nm). UV beams with the energy of 26 mJ/cm² exposed through microlens and it locally polymerizes the soft baked SU-8 monomer along the optical axis of microlenses (Step 9). Right after, post exposure bake is carried out in an oven at 90° C. for 20 minutes (Step 10). The difference in refractive index between exposed and unexposed portions is about 0.021. To prevent additional index change in the unexposed portion due to UV illumination, the device is heated at 150° C. on a hot plate. Eventually the index difference turns out to be Δn=0.029 and the index of the unexposed portion remains constant to additional UV illumination because photosensitive acid generator (a triarylium-sulfonium salt) is decomposed and loses functionality at temperature above 135° C. The crosslinked waveguide cores in artificial ommatidia can be visualized by dissolving non-photocrosslinked portion in a development solution prior to thermal crosslinking. However, in accordance with one embodiment, it has been shown, that waveguide cores with a high aspect ratio of more than 100:1 fall down due to surface tension during development. In addition, waveguide cores with a high ratio do not well represent the light path during UV illumination because the halfway crosslinked portions can also be dissolved due to resist contrast. As described earlier, the thermally crosslinked portion enclosing waveguide cores helps to support the structure of the waveguide core as well as to weakly guide the coupled light as cladding layer with lower refractive index.

To characterize the light propagation through artificial ommatidia 100, i.e. a microlens waveguide array, laser scanning reflection/transmission confocal microscopy (LSM) is adopted as a non-destructive method. The method has been recently used for optical sectioning of light passing through microlens smaller than 20 μm in diameter on a transparent substrate. The similar experimental setup is built under a laser scanning confocal microscope with additional apparatus that includes a right angle mirror on a goniometer with a one directional translation stage. It allows not only the precise optical sectioning of light propagating through polymer waveguides aligned to the focal plane of microlenses less than 50 μm in diameter but also the measurement of angular acceptance of artificial ommatidia. The optical sectioning facilitates the observation of light propagation through microlenses and waveguides, beam spot sizes at the focal plane of microlenses and waveguide cores, waveguide modes, and waveguide length. In the experimental setup, a right angle mirror is placed underneath the scanning stage of a laser scanning confocal microscope (Carl Zeiss™ LSM 510) to reflect collimated light coming from a diode laser with a wavelength of 635 nm onto the microlens. The device is flipped over so that microlenses collect the collimated light coming from a right angle minor. The photomultiplier (PMT) gain is determined by setting light intensity at the focal plane of the microlenses at maximum gain in order to avoid signal saturation due to focusing light during optical sectioning. Based on the experimental setup, the optical characterizations such as the focal length of microlenses, the length, diameter and mode of waveguides, and the coupling loss and angular acceptance of artificial ommatidia can also be carried out. The laser scanning confocal microscope (LSM) is useful in fully characterizing waveguide as well as microlens at small scale.

Optical sectioning for light at 635 nm coupled through the artificial ommatidia was performed with transmission confocal microscopy. The F-number, diameter, and Fresnel number of microlens in the particular artificial ommatidium are F/1.93, D^{L}=30 μm, and N_{F}=7.3, respectively. The intensity profile of the light propagating through the microlens prior to the formation of waveguide is measured along the distance to the focal plane and compared with the result of the optical simulation. The slightly asymmetric intensity distribution to the focal plane was experimentally observed as expected in the optical simulation for the low Fresnel number microlens. After UV exposure, the light guiding abruptly degrades due to the small difference in the refractive indices of waveguide core and cladding by the order of 10⁻³ or less. However, the increased difference in the refractive indice by 10⁻² after post exposure bake and hard bake significantly improves the light guiding effect. This effect can be explained with the V-number for each case. Under the assumption that the three-dimensional (3D) profiles of the coupled light at different wavelength represents the shape of the waveguides written by UV light, the lengths and diameters of waveguides can be measured from optically sectioned images obtained from transmission confocal microscopy.

Coupling efficiency n_{C} in artificial ommatidia 100 can be defined by the ratio of areal intensity at the lens focus to that at the waveguide core. The coupling efficiency depends on F-number of microlens. Collimated light at 635 nm was coupled into an artificial ommatidia formed by microlenses with different F-numbers (F/1.8, F/2.1, and F/2.9) and it was vertically scanned with 4 μm interval along the optical axis with the transmission confocal microscope. The areal intensity was first measured at the focal plane and then at the waveguide core located at 100 μm distance far from the focal plane. For F/1.8, the intensity profiles extracted from the confocal microscopic images at both planes are very similar and the light at 635 nm is successfully coupled with the efficiency of 0.69 dB. However the coupling efficiency significantly varies with F-number. The reason can be explained by the shape and index distribution of a polymeric cone formed prior to the waveguide during UV exposure. The shape and the index profile of a polymeric cone also significantly change with F-number and UV exposure energy.

As UV light converge the intensity increases and photopolymerization occurs at an energy above the threshold for polymerization. For lower F-number, the formation of a waveguide core occurs first and then the polymeric cone follows, while for higher F-number the polymeric cone occurs first and the waveguide follows. The preformation of the polymeric cone makes the focal length shorter due to higher index in the cone and then light starts diverging inside the polymeric cone. For microlenses with F/2.1, some portion of the light passing the focal plane diffracts without being coupled into the waveguide and it may result in the significant coupling loss of 2.62 dB. In the case of higher F-number, the preformation of the polymeric cone may cause the self-trapping effect prior to the focal plane and then cause the beam broadening at the focal plane. For F/2.8, the coupling efficiency may increase a little bit due to this broadening effect.

Assume that the coupled light represents the shape of the waveguide and polymeric cone. Depending on the F-number of microlens, the waveguide length, and the beam diameters at the waveguide core and the focal planes of microlens for polymeric cone were measured with the full width at 1/e² maximum (FWEM). In waveguide formation during UV exposure, optical intensity increases as UV light is focused through the microlens during the exposure. Before UV light arrives at the focus of the microlens, the energy reaches threshold to induce photopolymerization prior to the lens focus. The onset of photopolymerization makes a difference in refractive index and the phase front is self-trapped and the beam spot size is saturated after traveling to some distance. The core diameter varies slightly with F-number and ranges from 5.1 μm to 6.3 μm but it does not show a significant change if the resolution of the LSM is considered. It is observed that the diameters are larger than the theoretical minimum beam spot sizes of Rayleigh diffraction limit defined by d_{Rayliegh}=2.44 λ/F. It is because of diffusion in the photosensitive polymer resin during the photo-crosslinking. In the polymeric cone at the focal plane of the microlens, the diameter apparently increases with F-number. In the case of high F-number, it is observed that the preformation of the polymeric cone also causes elongation of the focal length but the diameter of the core eventually is optimized after UV light travels to some distance. That is why the core diameter is not affected while the cone diameter is broadened. In addition, it is observed that waveguide length also increases with F-number.

The diameters of waveguides in artificial ommatidia 100 are not sensitive to the F-number of the microlens. As described, V-numbers of F/1.8, F/2.1, and F/2.9 are 7.9955, 9.50411, and 7.6938, respectively and therefore the mode of waveguides can be determined by the superposition of 14 modes or less.

The angular acceptance function was also measured from LSM. In the experimental setup, the angle of the incident collimated light at 635 nm can be precisely changed by tilting a right angle mirror on two dimensional goniometers. The illumination area for artificial ommatidia is also connected by linearly translating the stage with the goniometers and the mirror. This alignment step needs to accompany every tilting step. Transmission confocal images at the plane of the microlens focus and waveguide core were taken for each small angle variation and the areal intensities at both planes were extracted from the images taken with different incident angles. The angular sensitivity is normalized by dividing the areal intensity at the waveguide core by that at the microlens focus.

The transmission spectra of light guided through the waveguide core and passing through the cladding have been measured with a microscope spectrometer with a broad band (470 nm-730 nm) white light source. The transmission spectrum with a maximum in a waveguide core is approximately 540 nm, while that in the surrounding cladding has transmission maxima at 525 nm. The spectral sensitivity of artificial ommatidia results from the electromagnetic properties of microlens-waveguide system due to the physical dimensions and the refractive index, while that of natural ommatidia depends on the absorption property of the photopigment as well as the electromagnetic properties.

It can be appreciated that artificial ommatidia comparable to those found in nature have been developed by polymer microlens technology and a self-writing process. The microlens assisted self-writing process has been optimized with FFT-BPM simulation. The optical characterization of microlens and waveguide systems at such a small scale has also been carried out with modified transmission confocal microscopy. Significantly, small angular acceptance angles and the spectral sensitivity have been measured. The anatomical and optical characteristics between artificial and natural ommatidia are also tabulated for convenience in the end.

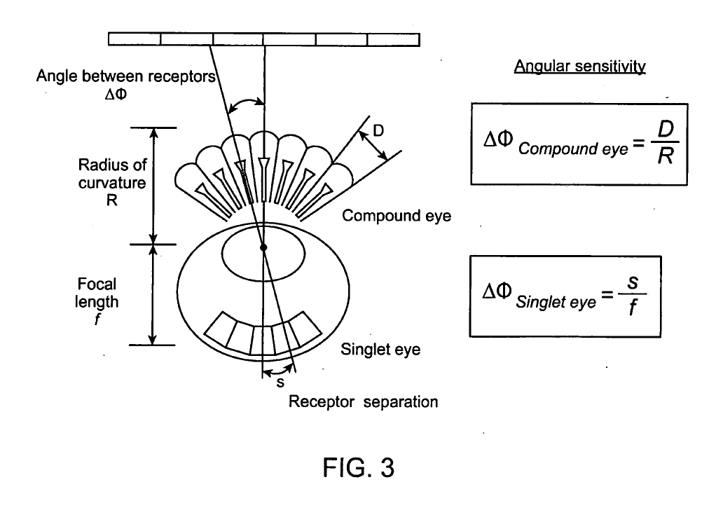

FIG. 3 shows a cross-sectional view of an angle between receptors comparing a compound eye to a singlet eye. As shown in FIG. 3, the angular sensitivity i.e., angle between receptors (ΔΦ) for a compound eye can be expressed as ΔΦ=D/R, and for a singlet eye ΔΦ=s/f, wherein D is the diameter of the microlens of the compound eye, R is the radius of curvature, f is the Focal length, and s is the receptor separation.

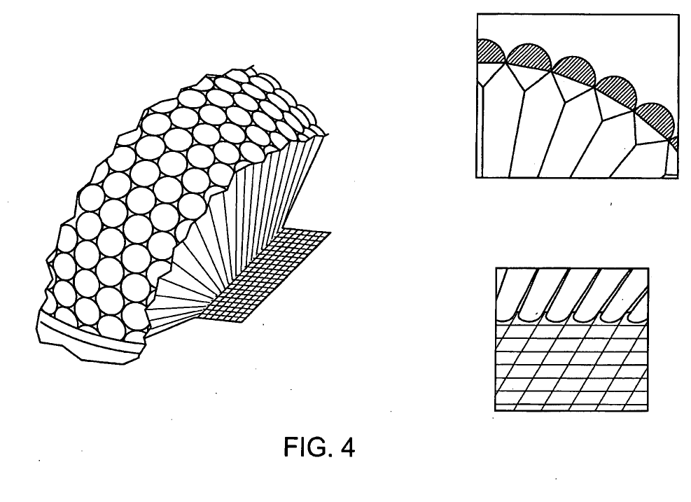

FIG. 4 shows perspective view of an artificial eye 10 having a plurality of artificial ommatidia 100 in the form of a honeycomb-packed polymer microlens array 20 on a curvilinear surface 30 in accordance with one embodiment. As shown in FIG. 4, it can be appreciated that a spherically arranged honeycomb-packed hexagonal microlenses replace the facet lenses of natural one and can be initially designed to have low Fresnel number (N_{f}<10). The light guiding portions under the microlens such as the polymeric cone, the waveguide core, or the cladding can be omni-directionally arranged on a curvilinear surface by reconfigurable microtemplating and a UV light induced self-writing process. Like crystal cones in nature, the polymeric cones that couple the impinging light through the microlens into the polymer waveguide are self-aligned under microlenses and the guided light arrives at the end of waveguide core. The light detection can be done by complementary metal-oxide-semiconductor (CMOS) image sensor arrays 40 or a conventional imaging system.

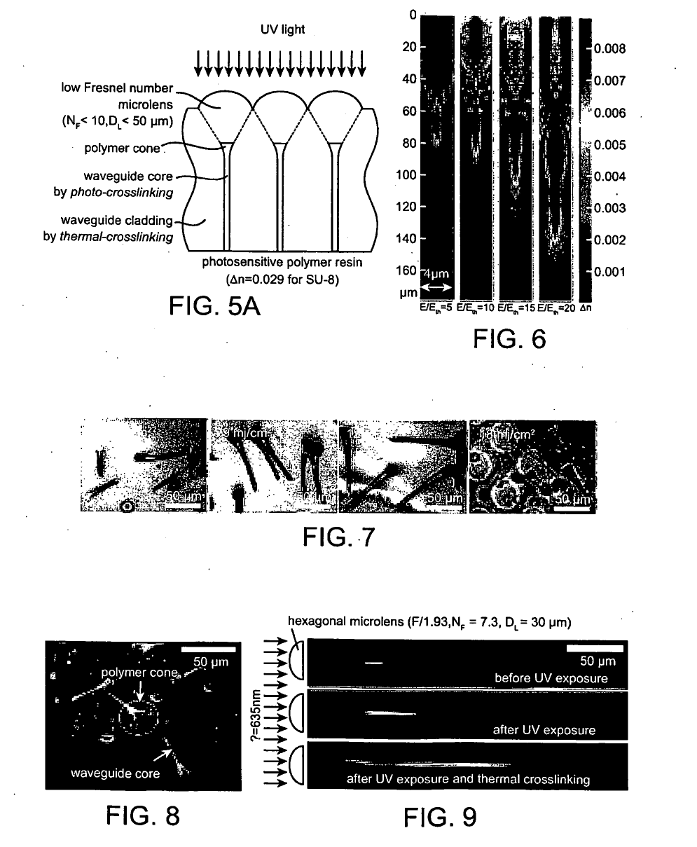

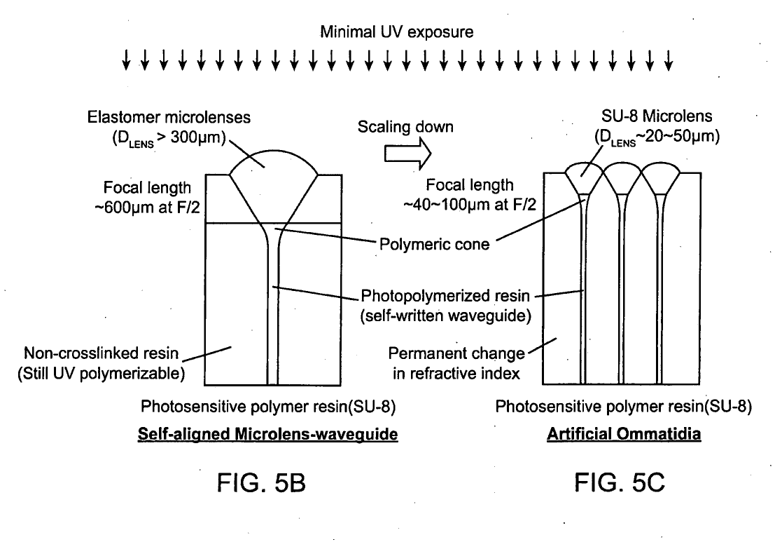

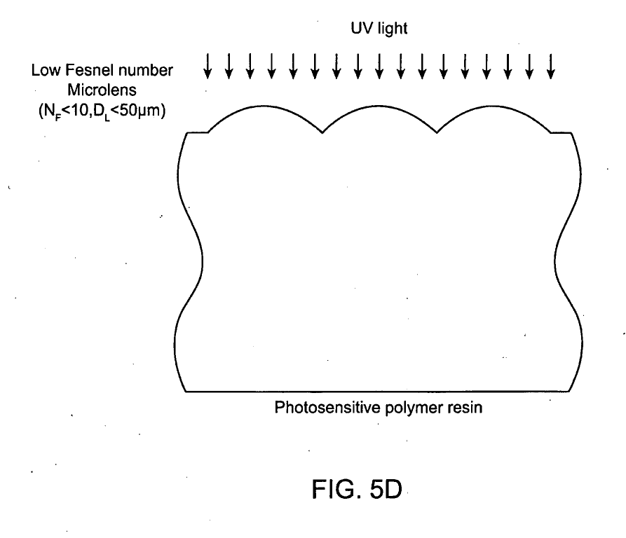

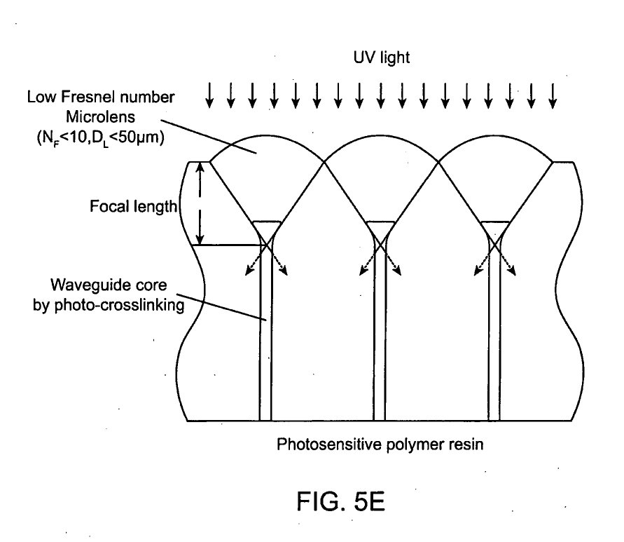

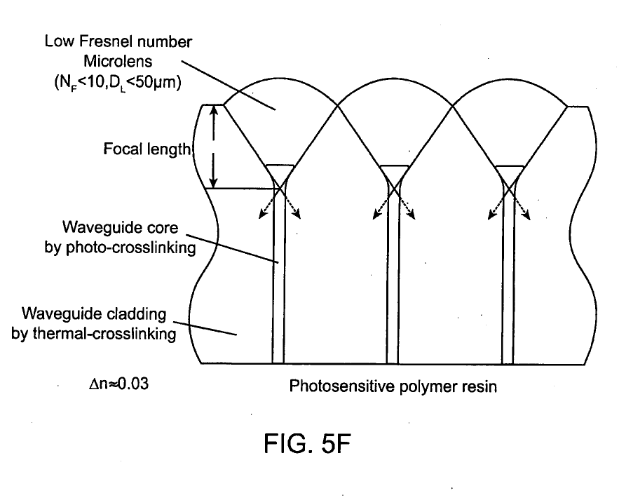

FIGS. 5A-5F show cross-sectional views of the polymer synthesis of artificial ommatidia 100, comprising a two-step cross-linking mechanisms in accordance with one embodiment. As shown in FIG. 5A, polymer synthesis of artificial ommatidia 100 can be done by using a microlens-assisted self-writing of waveguides 160 and two cross-linking mechanisms in a photosensitive polymer resin 60. Each of the artificial ommatidia 100 preferably includes a low Fresnel number microlens (N_{f}<10, D_{L}<50 μm) 110, a polymer cone 120, a waveguide core 130 by photo-crosslinking, and a waveguide cladding 140 by thermal-crosslinking. The artificial ommatidia 100 is preferably molded in a photosensitive polymer resin 60 having a Δn=0.029 for SU-8).

FIG. 5B shows a cross-sectional view of a photosensitive polymer resin 60 (such as SU-8) comprised of an elastomer microlens having a D_{LENS}>300 μm, and a focal length of approximately 600 μm at F/2, a polymeric cone 120, a photopolymerized resin (self-written waveguide 160), and a non-crosslinked resin (i.e., still UV Polymerizable).

FIG. 5C shows a cross-sectional view of the scaling down of the photosensitive polymer resin 60 upon UV exposure 70. As shown in FIG. 5C, the artificial ommatidia 100 includes a SU-8 microlens having a D_{LENS}˜20-50 μm, and a focal length of approximately 40 to 100 μm at F/2, a polymeric cone, a photopolymerized resin (self-written waveguide) having a permanent change in refractive index.

FIGS. 5D-5F show a cross-sectional view of a photosensitive polymer resin 60 having a low Fesnel number (N_{f}<10, D_{L}<50 μm), a waveguide core 130 by photo-crosslinking and waveguide cladding 140 by thermal-crosslinking with a Δn of approximately 0.03. It can be appreciated that Ultraviolet (UV) light 70 can be focused through the low Fesnel number (N_{F}) microlenses molded by a photosensitive polymer resin and self-trapped after passing the focal plane because of the refractive index change by the photopolymerization (FIG. 5E). The exposed portion above threshold energy for photopolymerization is photocross-linked by postbaking. The underexposed portion below threshold energy is still UV sensitive but is thermally cross-linked by heating above the temperature where a photoacid generator (PAG) in the photosensitive polymer resin 60 starts to degrade (FIG. 5F). At that point, the unexposed portion becomes insensitive to additional UV light.

In accordance with one embodiment, a commercialized negative tone photoresist (SU-8, Microchem Corporation, Newton, Mass.) was used as a photosensitive polymer resin 60. Initially the refractive index of an SU-8 monomer in a liquid phase, measured by an Abbe refractometer (ARIAS 500, Reichert, Incorporated, Depew, N.Y.), was nₘₒₙₒₘₑᵣ=1.550. The index of a 1.5 μm-thick thin monomer film can be prepared by spincoating and a soft bake, increased to 1.584 because of the evaporation of SU-8 solvent, that is, gamma butyrolactone (GBL). After UV exposure of 900 mJ/cm2 and a postexposure bake, the index change measured by a spectroscopic ellipsometer increases up to Δnₚₕₒₜₒ=0.021, and the fully photocross-linked SU-8 index was nₚₕₒₜₒ=1.605. After thermal cross-linking, the index of the exposed portion fully cross-linked by UV was constant, but that of the unexposed portion decreased by 0.008. Consequently, the maximum index change between both cross-linking core and cladding eventually turned out to be Δn_{SU-8}=0.029.

FIG. 6 shows a simulated refractive index distribution of polymer waveguides 160 formed by microlens-assisted self-writing by four different values of E, wherein Eth is the threshold irradiation dose that can initiate the crosslinking process in the polymer. As shown in FIG. 6, the formation of the self-written waveguide during UV exposure was simulated by using a fast Fourier transform-based beam propagation method. In the simulation, the propagating exposure beam, while being diffracted by the index distribution, imparts photon energy to the photosensitive medium and modifies its refractive index as well. The modified refractive index profile was used to simulate the next round of propagation, and so on. The imparted energy, or the irradiation dose, E, at one location has been calculated as the product of the field intensity at that point and the unit time duration. The increase in the refractive index is approximated to be linear between the initial and the saturated indices.

The microlens first focuses the exposure beam with about 50 μm of back focal length. The initial beam intensity and the unit time duration have been iteratively optimized to initiate the self-writing process from the focal point. The relatively large refractive index contrast of the photosensitive resin facilitated the formation of a straight, over-100-μm-long waveguide. The “diffusion” of the refractive index due to the chemically amplifying nature of the photosensitive resin (SU-8) was ignored in this simulation. As a result, the simulated waveguide was thinner than the one obtained experimentally. The rough surface of the simulated waveguide, in contrast to the smooth surface of the actual self-written waveguides, can also be ascribed to the exclusion of the diffusion effect. The combined action of the high index contrast and the diffusive, self-smoothing index profile was required to improve the efficiency of the self-writing process. Other than that, the simulated index profiles taken when E reaches 5 to 20 times the value of the cross-linking threshold, Eth, exhibited good qualitative agreements with the observed waveguide structures.

In our experiment, with the use of the previous method, the formation of large-scale artificial ommatidia self-written by 300-μm microlenses depended on UV exposure energy.

FIG. 7 shows the formation of polymer cones and waveguide cores self-written by 300 μm diameter microlenses depending on UV exposure. As shown in FIG. 7, it turned out that the formation of a polymer cone occurs after that of a waveguide core as UV exposure energy increases.

FIG. 8 shows a dark-field micrograph of polymer cones and waveguide cores placed on a substrate after completely dissolving unexposed portions in a solvent before thermal cross-linking. As shown in FIG. 8, at the level of hexagonal microlens of 25 μm in diameter, the formation of polymer cones and waveguide cores was also visualized by dark-field optical microscopy. The visualization was accomplished by dissolving unexposed portions in a solvent before thermal cross-linking. Polymer cones and waveguide cores were placed on a substrate because of the high aspect ratio of core diameter to core length.

FIG. 9 shows an optically sectioned confocal micrographs of light at 635 nm coupled through an artificial ommatidium before UV exposure (only microlens), after UV exposure (waveguide core by photocross-linking), and after UV exposure and thermal cross-linking. As shown in FIG. 9, the light guiding (λ=635 nm) through artificial ommatidia has also been demonstrated by optical sectioning along the optical axis with a laser scanning transmission confocal microscope. An artificial ommatidium after thermal cross-linking (microlens with F number of 1.93 (F/1.93), lens diameter of 30 μm (D^{L}=30 μm), and N_{F}=7.3; index difference between waveguide core and cladding was 0.029) showed strong light guiding in comparison with only a microlens or with only UV photopolymerization.

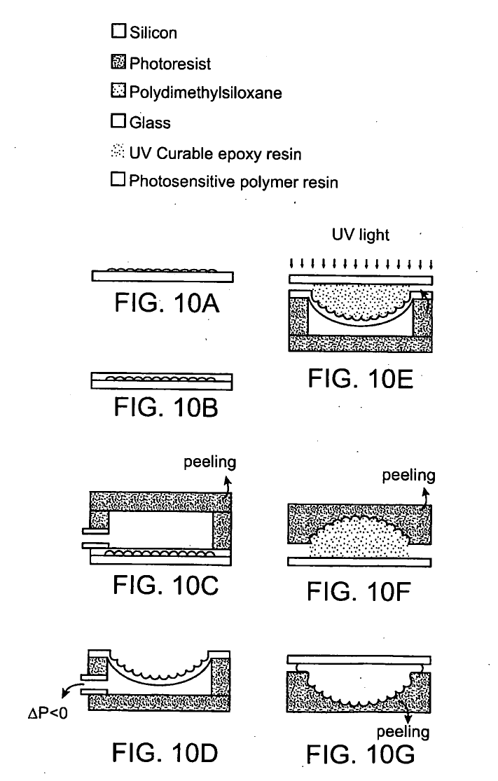

FIGS. 10A-10G show a cross-sectional view of a three-dimensional (3D) polymer synthesis of biomimetic artificial compound eyes 10 in accordance with one embodiment. It can be appreciated that the spherical configuration of artificial ommatidia 100 can be achieved through a polymer replication process by reconfigurable microtemplating, that is, the polymer replication using the deformed elastomer membrane with microlens patterns and self-written waveguides with a lens-assisted UV exposure for self-written waveguides. Honeycomb-packed hexagonal photoresist microlens arrays 220 were prepared on a silicon substrate 210 (FIG. 10A), and the lens template was molded onto a 22-μm-thick slab of polydimethylsiloxane (PDMS) elastomer 230 (FIG. 10B). In accordance with one embodiment, the PDMS elastomer monomer 230 (10 mL, monomer: curing agent=10:1) was spincoated at 3500 rpm on the template for the replication and cured at 90° C. in an oven for 3 hrs. For reconfigurable microtemplating, a 5-mm-thick PDMS elastomer slab 230 with a microfluidic channel and a 2.5 mm in diameter circular through-hole perforated by mechanical punching was permanently bonded to a 22 μm-thick PDMS replica of concave microlenses after an oxygen plasma surface treatment. The microlens replica was then released from the microlens template (FIG. 10C). Negative air pressure ranging from 5 to 30 kPa was applied through a microfluidic channel to deform the PDMS membrane with concave microlenses (FIG. 10D). A solvent-free UV-curable epoxy resin 250 (Norland optical adhesive 68, Norland Products Incorporated, Cranbury, N.J.) was precisely dispensed onto the deformed elastomer membrane, covered with a glass coverslip 240, and then fully cross-linked for 2 hours with UV light 70 of 0.5 mW/cm2 (FIG. 10E). For a batch replication, a three-dimensional (3D) master mold was prepared with a five-by-five array of the three-dimensional (3D) epoxy resin replicas with different curvatures glued on a Petri dish, and the master mold was again replicated with PDMS (FIG. 10F). The pattern polarity of the three-dimensional (3D) PDMS replica was reversed by molding it with a commercial photosensitive polymer resin 260 (NANO SU-8, formulated in cyclopentanone). The volume of 40 μL was precisely dispensed in each concave dome and prebaked at 120° C. for 20 min to remove the solvent. An additional prebake process was also carried out at 120° C. for 1 hour right after covering each droplet with a 10-mm-diameter circular glass (FIG. 10G). The SU-8 replica with convex microlenses along the circumference kept its shape up to 120° C. because the glass transition temperature of SU-8 increases with the soft-bake temperature. However, the microlens patterns on an SU-8 droplet may disappear with an insufficient prebake. In particular, the release of the SU-8 replica needs to be carried out at room temperature; otherwise, the gel-like SU-8 may not completely release from the PDMS mold.

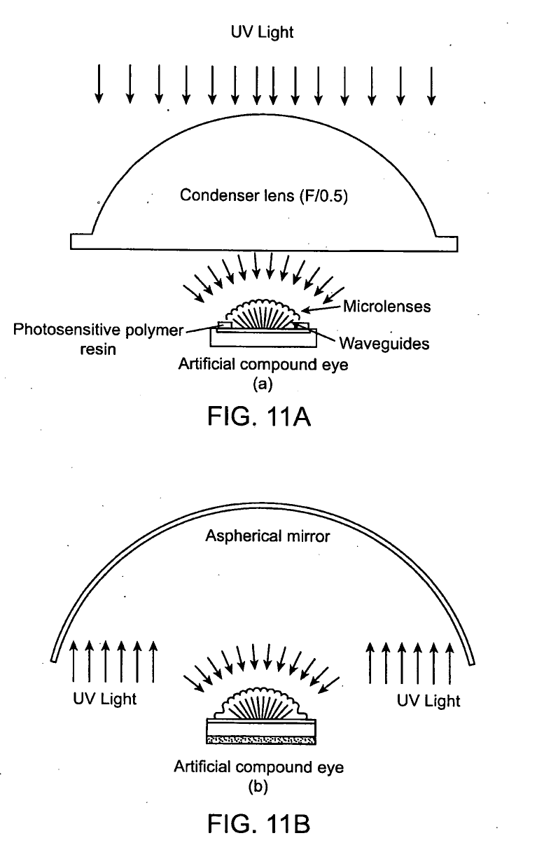

Next, a partially coherent UV light source from a photolithographic tool (e.g., Q4000 MA, Quintel Corporation, Morgan Hill, Calif.; 12 mW/cm2 at 365 nm) was used to form a polymer cone and a waveguide under each microlens. The spherical arrangement of artificial ommatidia was determined by the spherical illumination of UV light, which can be achieved with a spherical mirror or a high numerical aperture (NA) condenser lens. In the experiment, an aspheric condenser lens (lens diameter of 23 mm, F/0.5, and back focal length of 6.9 mm) was chosen for ease of use in the experiment even though the angular span was limited by the NA of the condenser lens (FIG. 11). For instance, the illumination angle for F/0.3 is plus or minus (±) 45°. However, a spherical mirror-assisted illumination is recommended for UV illumination with a wide angle. It can be appreciated that in accordance with one embodiment, the cladding of artificial compound eyes can be made of a polymer material with lower index in a solid phase so that it can mechanically support obliquely-standing waveguide cores as well as assist light-guiding. For example, in one preferred embodiment, a photosensitive polymer resins such as SU-8 contain the solvent in a liquid phase at room temperature, which can be evaporated by heating is preferred.

The spherical illumination can be done by a spherical mirror or a low F-number lens as shown in FIG. 11A. Using an aspheric condenser lens 300 (D_{L}=23 mm, F/0.5, and f_{β}=6.9 mm) a lens assisted spherical exposure method is chosen in this experiment due to the easiness of experimental set-up even if the angular span is limited by the F-number of the condenser lens. For instance, the illumination angle for F/0.5 is ±45°. However, a spherical mirror 310 assisted illumination is recommended for UV illumination with wide angle. Spherically UV exposed SU-8 replica is then post exposure baked at 90° C. in an oven for 15 minutes (mins) for photo-crosslinking and finally followed by hard bake at 150° C. for 3 hours (hrs). The complete artificial compound eye is also shown in FIG. 11B.

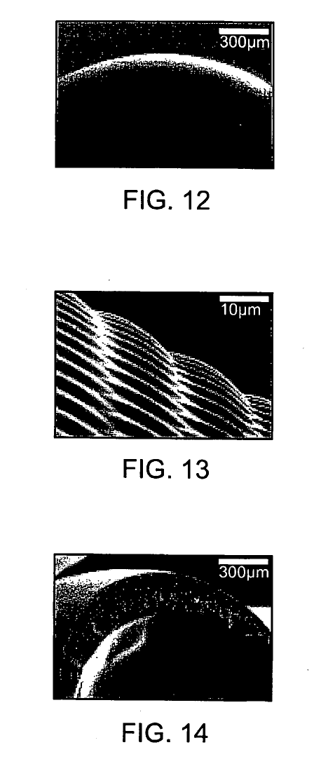

The spherically UV-exposed SU-8 replica is post-exposure baked (at 90° C. for 15 min) for photocross-linking and finally hard baked (at 150° C. for 3 hours) for thermal crosslinking. Two scanning electron microscope (SEM) images showed that honeycomb-packed hexagonal microlenses of about 8370 (F/2.2, 25 μm in diagonal) are spherically arranged on a hemispherical polymer dome 2.5 mm in diameter (FIGS. 12 and 13). Under the microlenses, self-aligned polymer cones 120 and waveguide cores 130 as well as cladding 140 were observed by a cross-sectional scanning electron microscope (SEM) image (FIG. 14).

The curvature of the dome of SU-8 replica is controlled with the deformation of the thin elastomer membrane of a reconfigurable microtemplate as described earlier. The radius of curvature of the SU-8 replicas is measured with an interferometric optical profiler (Wyko NT 6000). The reconstructed optical image measured from a SU-8 dome of 2.5 mm in diameter with honeycomb-packed hexagonal microlenses of 25 μm in diagonal, obtained from the thin elastomer membrane deformed at 15 kPa. A small dot in the image indicates each microlens and about 8,370 microlenses are arranged along the circumference of a polymer dome (2.5 mm in diameter). It can be appreciated that in accordance with one embodiment, the curvatures of the polymer domes depends on the applied pressures. In addition, the radius of curvature also decreases polynomially with the applied pressure. Small ripples on each curvature profile also represent the profiles of microlenses. Excessive pressure may cause distortion at the edge of the deformed thin elastomer membrane that is transferred to the SU-8 replica.

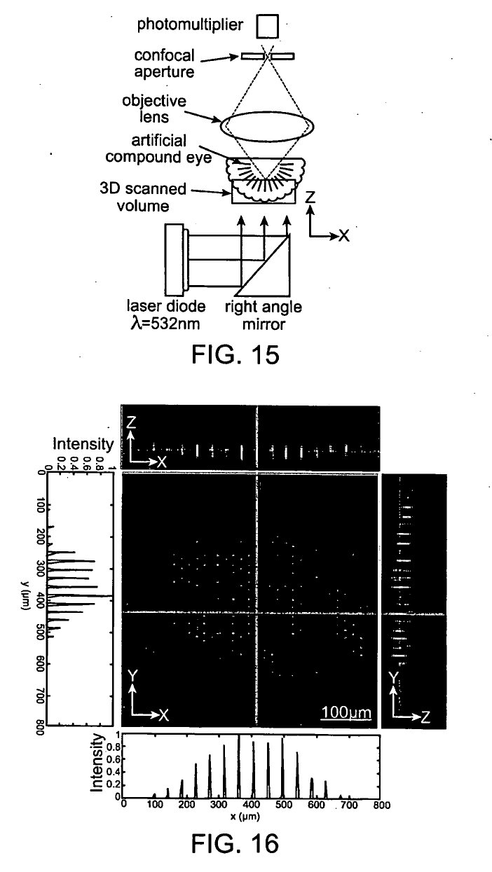

The optical characteristics of artificial compound eyes were carried out using the identical experiment set-up of a reflection/transmission confocal microscope (Zeiss LSM510) with additional apparatus of a laser 460, two-axis goniometers, and a right mirror 450. As shown in FIG. 15, the collimated laser light 460 of 5 mW at a wavelength of 532 nm impinges onto the microlenses 110 spherically arranged along the circumference of an artificial compound eye 10. The incident angle can be controlled by rotating the right mirror 450 on the two-axis goniometer. In this experimental set-up, the maximum detection area for the 10× objective lens is 1.5 mm×1.5 mm and the maximum vertical scanning length is 3 mm. As shown in FIG. 15, the experimental set-up 400 can include a photomultiplier 410, a confocal aperture 420, an objective lens 430, an artificial compound eye, a 3D scanned volume 440, a right angle mirror 450 and a laser or laser diode 460.

FIG. 16 shows an optically sectioned three-dimensional (3D) confocal image of an artificial compound eye 10 coupled with normal incident light at 532 nm and the intensity distribution obtained along line a-a and b-b. Light from point light sources at infinity were coupled into the omnidirectionally arranged ommatidia with different coupling efficiency because each ommatidium covered a different direction. Consequently, the angular sensitivity function (ASF) of a single ommatidium can be reconstructed by measuring the relative intensity of the light at the distal end of each ommatidium. The angular sensitivity function (ASF) of a single ommatidium in an artificial compound eye was measured by performing 3D optical sectioning based on laser scanning confocal microscopy. The optical sectioning of the artificial compound eye was carried out under normally incident light at 532 nm with a transmission confocal microscope (e.g., Zeiss 510, Carl Zeiss MicroImaging, Incorporated, Thornwood, N.Y.).

Starting from the apex of the artificial compound eye, the vertical scanning was performed over a range of 200 μm with a 2 μm increment. At each vertical increment, a 765-μm-by-765-μm area perpendicular to the incident light was laterally scanned with a 0.8-μm resolution. The confocal image on the xy plane was taken at 80 μm below the apex of the artificial compound eye. The cross-sectional confocal images scanned along the lines a-a and b-b are also shown at the top and right sides of the main image, respectively. The distributions of the relative output intensity measured along the two lines at the vertical position are also included on the bottom and left sides, respectively. The relative intensity of each peak represents the sensitivity of an individual ommatidium to different incidence angles. The observed distributions of relative intensity in x and y directions are slightly asymmetric because of the honeycomb packing of hexagonal microlenses. To obtain the ASF of a single ommatidium, the orientation of each waveguide was measured from the vertically scanned confocal images.

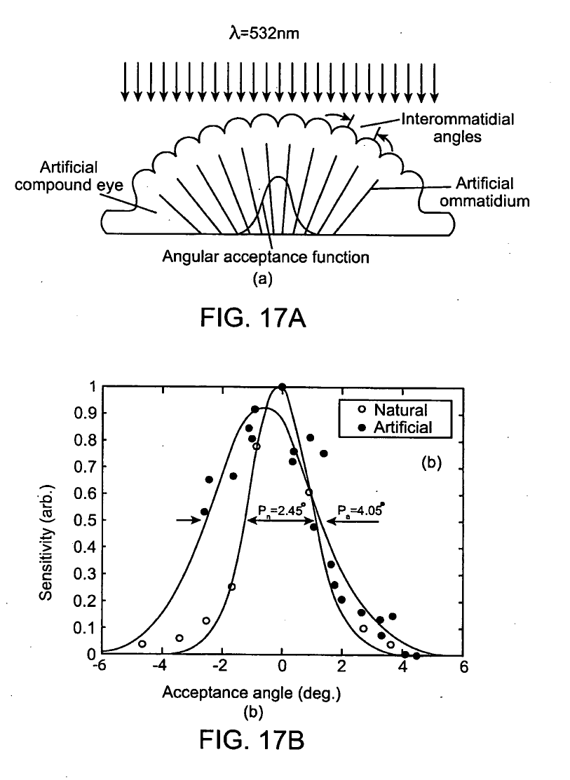

The relative intensity distribution was plotted with respect to the incidence angle (FIG. 17B). If a general symmetry is assumed, the acceptance angle, or the full width at half maximum of the measured ASF, is 4.4°. The value is comparable to those of natural compound eyes, which range from 1.60 to 4.7°. As shown in the superimposed curve, the acceptance angle of a worker bee ommatidium is ˜2.5°. The theoretical ASFs was also constructed by using the lens-waveguide coupling model proposed by Stavenga. The model takes both the diffraction by microscale lenses and the excitation of waveguide modes by the diffraction image into consideration. The results of reconstruction using only the fundamental waveguide mode were also superimposed in FIG. 17B. The optical and structural parameters of the worker bee reported by Laughlin and Horridge and Snyder and Pask were used, and the use of only the fundamental mode of cylindrical waveguides for the reconstruction led to the best fit with experimental data for both cases was pointed out. Although the approximation may be acceptable for waveguides in worker bee ommatidia, which support only two modes, it may not be applicable to the waveguides of artificial ommatidia, which support more than 10 modes. The unexpected agreement between the measured ASF and the single-mode approximated reconstruction suggests that the index distribution of the self-written waveguides deviates from the step profile and hence degrades the model. The current artificial ommatidium exhibits an acceptance angle wider than the interommatidial angle (˜1.5°), and it will suffer from overlap-induced image degradation. The main reason is that the curvature of the eyelet is increased by the large deformation of a polymer membrane during the polymer replication process. However, this problem can be resolved by controlling the local distribution of the microlenses. The optical sectioning technique not only enabled the visualization of the light propagation through microlenses but also facilitated the precise measurement of beam spot sizes at the focal plane of the microlenses and waveguide cores, waveguide modes, coupling loss, waveguide length, and most importantly the angular acceptance. More optical measurement results were comparable with the previously measured characteristics of the bee. The results showed that both the physical dimensions and the optical characteristics of our artificial ommatidia were very comparable to those found in nature. Therefore, this 3D polymer fabrication method of biologically inspired optical systems can be used in a broad range of optical applications, such as data storage and readout, medical diagnostics, surveillance imaging, and light-field photography.

It can be appreciated that when point light sources at infinity impinge on an artificial compound eye 10, they are coupled into spherically arranged ommatidia depending on the incident angle to the pointing angle. Since each ommatidium covers different direction due to the spherical arrangement, the angular sensitivity of ommatidia depends on the pointing angle. The collection of point spread functions obtained from each ommatidium represents the angular acceptance function of a single ommatidium as shown in FIG. 17A. Since artificial ommatidia are spherically arranged along the circumference of a polymer dome, they point in slightly different directions and have different coupling efficiencies to normal incident light. When the incident light illuminates artificial compound eye in a perpendicular direction, each ommatidium provides different point spread functions depending on the orientation of the ommatidium. Each orientation was measured from vertically scanned confocal images. The full width at half maximum (FWHM) of the measured angular acceptance functions is 4.05°, which is comparable to that in natural compound eyes ranging from 0.1° to 10°. For instance, angular acceptance of a housefly Calliphora is 2.45°.

In accordance with one embodiment, an artificial compound eye lenses is anatomically similar to natural compound eyes when constructed in three-dimensional configuration. Among the optical types of natural compound eyes, the type of artificial compound eyes corresponds to a transparent apposition eye found in crustaceans since they rely on a similar method for optical isolation between ommatidia without pigments. The angular acceptances and interommatidial angle in an artificial compound eye can be designed and optimized for the required resolution as an engineering point of view. As an extremely different type of optical systems unlike single aperture optical systems, artificial compound eye lenses can serve as an appropriate approach for miniaturizing a vision system above diffraction limit since it can take full advantages of microoptics.

In addition, biologically inspired microfabricated compound eye lenses have been developed by mimicking the unique optical scheme of the natural compound eyes found in many insects. The combination of polymer microlenses, reconfigurable microtemplate, soft lithography and self-written waveguides enables the realization of complicated optical structures with thousands of omnidirectional self-aligned microlens and waveguide arrays in a photosensitive polymer resin.

In the artificial compound eye lens described here, replicated polymer microlenses are substituted for the facet lenses in natural compound eyes. The spherical configuration of the microlenses has been achieved by a replication process of reconfigurable microtemplates, i.e., the polymer replication using the deformed elastomer membrane with microlens patterns. The formation of self-aligned polymer waveguides with microlenses has been accomplished by a self-writing process in a photosensitive polymer resin. Characterizations of artificial ommatidia and compound eyes have been carried out with a modified reflection/transmission confocal microscope with additional apparatus. The comparative discussion between natural and artificial compound eye has been also described. It can be appreciated that artificial compound eyes offer a promising new paradigm for constructing miniaturized imaging systems, which are different from the singlet aperture imaging systems currently being used. Moreover, the unique optical scheme of each natural compound eye, which is functionally optimized to the environment for survival, can be utilized for a wide range of engineering applications.

It can be appreciated that a wide variety of photosensitive polymer resins can be selected as material for the formation of self-written waveguides in artificial compound eye lens. In accordance with one embodiment, a commercialized negative tone photoresist (Nano™ SU-8) has been used as a photosensitive polymer resin 60. However, it can be appreciated that any suitable polymers or polymer materials which exhibit nonlinear optical effects of self-focusing and trapping can be used. Each resin shows the different increment in refractive index depending on UV exposure. In order for a photosensitive polymer resin to be applicable for artificial compound lenses, the following requirements must be met: increment in refractive index during photopolymerization, high optical transmission at visible wavelengths, and solidification after the soft bake. If there requirements are satisfied, the photosensitive polymer resins should be able to control the waveguide formation as well as the difference in refractive index between waveguide core and cladding. High penetration depth at the specific wavelength of UV light is also important when used in a self-writing process, because it can increase the physical length of the waveguide. In addition, the controlled index difference helps modulate the light-guiding as well as light-coupling in artificial ommatidia.

Natural compound eyes achieve regional sensitivity by differentiating the diameter or the directions of the optical axes of facet lenses on the eyelet. The diameter gradually decreases from the front to the back or from top to the bottom of the eye. For light coming from certain directions, larger facet lenses in certain locations on the eye make it possible for their ommatidia to have a higher resolving power. Even if the facet lenses have an equal distance apart on the surface eyelet, the optical axes are not the same as the interommatidial angles. They are tilted toward one another so that they are nearly parallel, thus giving one segment of the visual world more than its share of the distribution of sampling points.

The regional sensitivity can also be achieved in an artificial compound eye lens by changing the aperture size, the packing density of microlens or the incident angle of UV light during the formation of the self-written waveguides. In order to create a wide range of the incident angle of UV light the special exposure system with a spherical or aspherical mirror is required.

Among a number of known types of natural compound eyes, the afocal apposition eye found in butterflies, close relatives of the moths with superposition eyes, has a unique trait. Anatomically, this eye is indistinguishable from other apposition compound eyes; however, the function of the crystalline cone is different. The facet lens is sufficient to focus an image at the distal rhabdomere tip inside the crystalline cone that behaves as a powerful lens. The light is recollimated and coupled into a rhabdomere. The afocal ommatidia, like a telescope system with considerable power, are about 10 percents more efficient in accepting on-axis light than other types of apposition compound eye.

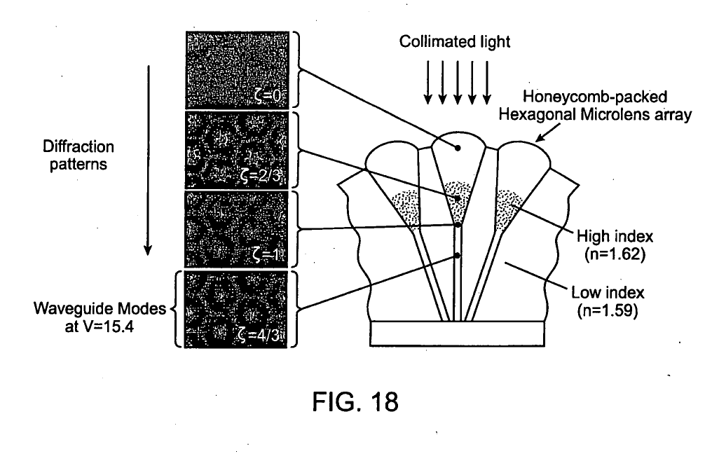

FIG. 18 is the signature of light-guiding through ommatidia in an artificial compound eye. The diffraction patterns are taken along the optical axis of the artificial ommatidia under the collimated light at 532 nm passing through honeycomb packed hexagonal microlenses (F/1.9, D₁=25 μm in diagonal, D_{core}=5.5 μm, L_{core}=200 μm). Normalized distance ζ is defined as the distance along the optical axis to the lens focal length. Initially the pattern shows the diffraction pattern of hexagonal microlens at ζ=0. The pattern is changed into a circular shape along the optical axis as the light propagates to the focus ζ=2/3. The beam diameter is minimized at focus ζ=1. After focus, the light is coupled and guided in a waveguide with the coupling efficiency of 1 dB, measured by the ratio of area intensity at waveguide core to that at microlens. The diffraction pattern at ζ=4/3 remains constant until the end of waveguide core.

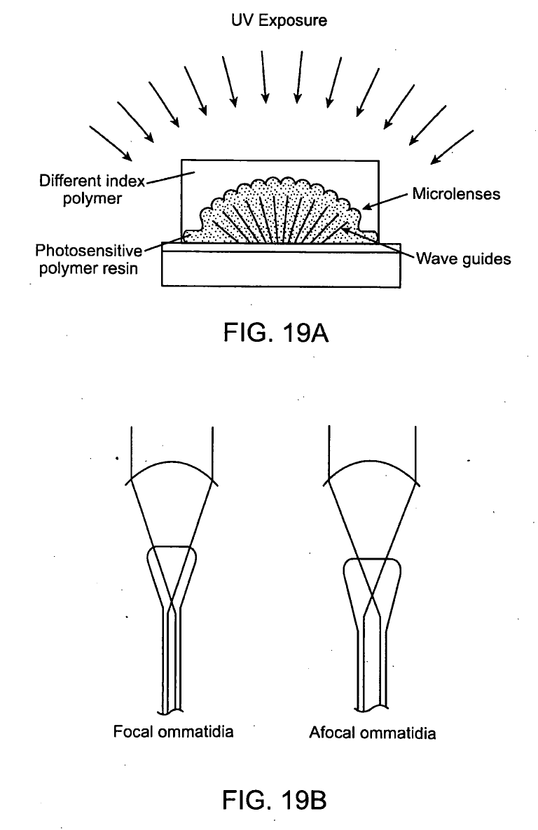

The special optical scheme can also be applied to artificial compound eyes as shown in FIGS. 19A and 19B. As shown in FIGS. 19A and 19B, during UV exposure a polymer dome with microlens 110 arrays can be wrapped by a polymer 80 of different refractive index and the waveguides 160 are formed at the distal focus. The polymer wrapping temporally changes the focal length of microlens during the exposure as shown in FIG. 19B (focal ommatidia 400 and afocal ommatidia 410). After removal of the wrapping, the artificial compound eye 10 exposed to air has shorter focal length and the impinged light through microlenses 110 is focused in the front of waveguide tips. This light is recollimated inside polymeric cones and coupled into waveguides. The scheme also provides the similar functions in artificial compound eyes as shown in the compound eye of butterflies.

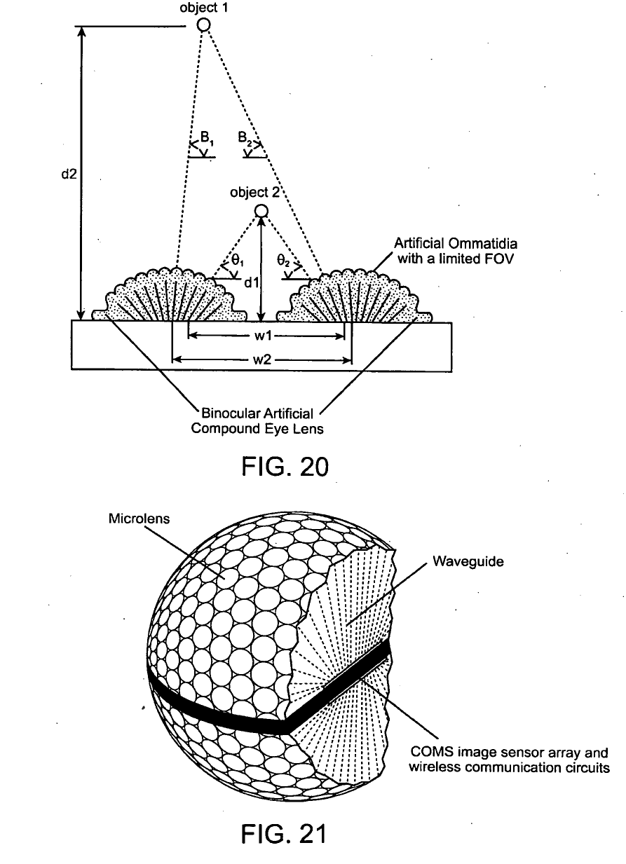

An optical scheme of binocular vision in natural compound eyes can be applied for identifying distance with artificial compound eyes. Insects with compound eyes seem to use binocular vision mainly to localize distinct moving objects as well as to construct a three-dimensional imaging of the world around them. The binocular artificial compound eyes 500 can also be microfabricated by using a reconfigurable microtemplate with two deformed elastomer membranes with microlens arrays. Since individual ommatidium collects light with small angular acceptance, the known distance between two ommatidia and the pointing angles can provide the distance to the object as shown in FIG. 20.

In miniaturized optical imaging systems, the resolution of compound eye 10 type imaging systems can compete with that of camera type imaging systems. Even if it is lower in a bulky scale. Artificial compound eye lens can be applied for endoscopic imaging with wide field-of-view (FOV) inside the human body or inaccessible small cavities and moreover an endoscopic optical capsule for full view imaging as shown in FIG. 21 can be realized by combining a Complementary Metal-Oxide-Semiconductor (CMOS)-based or other technology-based image array 40 and an integrated circuit for wireless communications with two artificial compound eye lenses. Each individual lens can cover the field of view (FOV) of 180° and both lenses can even cover the field-of-view (FOV) of 360°. It can be appreciated that artificial compound eye lens can be used in a wide variety of field-of-view miniaturized imaging systems and omni-directional sensor arrays.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. An artificial compound eye, comprising:
a plurality of three-dimensional (3D) self-aligned polymer microlenses disposed on a curvilinear surface; and
a plurality of waveguides, wherein each of the waveguides is in optical communication with one of the plurality of polymer microlenses.

2. The compound eye of claim 1, wherein the microlenses are disposed in a honeycomb pattern on the curvilinear surface.

3. The compound eye of claim 1, wherein the polymer microlenses are formed into an elastomeric material.

4. The compound eye of claim 1, wherein the individual waveguides are optically isolated from one another.

5. The compound eye of claim 1, wherein the waveguides are formed by a self-writing process in a photosensitive polymer resin.

6. The compound eye of claim 5, wherein the waveguides are formed by changing the refractive index in the photosensitive polymer resin.

7. The compound eye of claim 6, wherein each polymer waveguide has a higher index solid core surrounded by a lower index solid cladding in the photosensitive polymer resin.

8. The compound eye of claim 7, wherein each of the waveguides are surrounded by a thermal cross-linked resin.

9. The compound eye of claim 7, wherein the core of each of the waveguides are formed by photo crosslinking.

10. The compound eye of claim 5, wherein each waveguide is formed at the focal plane and the optical axis of the microlens.

11. The compound eye of claim 1, further comprising:
a sensor array in optical communication with the waveguides, wherein each sensor in the sensor array is in optical communication with one of the waveguides.

12. The compound eye of claim 11, wherein the optical sensor array is a Complementary Metal-Oxide-Semiconductor (CMOS)-based or other technology-based image array.

13. The compound eye of claim 1, wherein the diameter of each microlens is less than 300 μm.

14. The compound eye of claim 1, wherein the waveguide is formed from the same material as the microlenses.

15. The compound eye of claim 1, wherein the waveguide is formed from a different material from the microlenses.

16. The compound eye of claim 1, wherein the curvilinear surface is a polymer having a curvature controlled by pressure during microtemplating or microstamping.

17. The compound eye of claim 5, wherein the waveguides are formed by exposure of the photosensitive polymer resin to ultraviolet light.

18. The compound eye of claim 17, wherein the ultraviolet light passes through a condenser lens.

19. The compound eye of claim 17, wherein the ultraviolet light passes through an aspherical lens.

20. A method of using the compound eye of claim 1, wherein the compound eye is used in an omnidirectional sensor array.

21. A method of using the compound eye of claim 1, wherein the compound eye is used for three-dimensional (3D) holographic optical data storage write/reader.

22. A method of using the compound eye of claim 1, wherein the compound eye is used in three-dimensional (3D) confocal microcopy.
